(19) United States
(12) Patent Application Publication
(10) Pub. No.: US 2019/0197480 A1
(43) Pub. Date: Jun. 27, 2019

(54) RECOMMENDING RELEVANT POSITIONS

(71) Applicant: Microsoft Technology Licensing, LLC, Redmond, WA (US)

(72) Inventors: Huichao Xue, Santa Clara, CA (US); Dhruv Arya, Sunnyvale, CA (US); Nadia Fawaz, Santa Clara, CA (US); Liang Zhang, Fremont, CA (US)

(21) Appl. No.: 15/850,483

(22) Filed: Dec. 21, 2017

(51) Int. Cl. G06Q 10/10; G06Q 50/00; G06F 17/30; G06N 99/00

(52) U.S. Cl. CPC G06Q 10/1053; G06Q 50/01; G06N 99/005; G06F 17/30554; G06F 17/30867

(57) ABSTRACT

This disclosure relates to systems and methods for recommending relevant positions. A method includes receiving a request from a member for available employment positions posted at a social networking service, determining a cohort for the member, retrieving a query that is associated with the cohort for the member, executing the query at a database of employment positions, receiving results of the query, and causing the results of the query to be displayed, using an electronic user interface, to the member.

### TECHNICAL FIELD

The subject matter disclosed herein generally relates to recommending relevant positions and, more particularly, to constructing a query for a member seeking relevant employment positions according to a cohort to which the member belongs.

### BACKGROUND

A common feature of social networking services includes allowing members to search for employment positions. In certain examples, determining relevant positions among millions of positions and hundreds of millions of members is computationally prohibitive.

In one example, a system is configured to perform a detailed search for alternative positions for a member. However, searching in millions of positions for hundreds of millions of members of a social networking service exceeds available computing resources. This is especially the case as available positions postings are regularly deleted and/or added. Furthermore, in unique or specific groups of members, a detailed search will yield too few results.

In another example, another system is configured to perform a less detailed search. This approach is computationally less expensive; however, it returns too many results and may require user involvement.

### BRIEF DESCRIPTION OF THE DRAWINGS

Some embodiments are illustrated by way of example and not limitation in the figures of the accompanying drawings.

FIG. 1 is a block diagram illustrating various components or functional modules of a social networking service, in an example embodiment.

FIG. 2 is a block diagram illustrating a system for recommending relevant positions, according to one example embodiment.

FIG. 3 is a flow chart diagram illustrating a method for recommending relevant positions, according to one example embodiment.

FIG. 4 is a flow chart diagram illustrating another method of recommending relevant positions, according to one example embodiment.

FIG. 5 is a flow chart diagram illustrating a method of training a machine learning system, according to another example embodiment.

FIG. 6 is a flow chart diagram illustrating a method of training a machine learning system, according to another example embodiment.

FIG. 7 is a block diagram illustrating a system for determining a cohort for a member, according to one example embodiment.

FIG. 8 is a block diagram illustrating a representative software architecture, according to one example embodiment.

FIG. 9 is a block diagram illustrating components of a machine, according to some example embodiments, able to read instructions from a machine-readable medium a hardware machine-readable storage medium) and perform any one or more of the methodologies discussed herein.

### DETAILED DESCRIPTION

The description that follows includes systems, methods, techniques, instruction sequences, and computing machine program products that embody the inventive subject matter. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Described herein is a system configured to identify one or more relevant employment positions for a member of an online social networking system in response to the member requesting available positions.

Currently, there is a specific technical problem with respect to recommending relevant positions. A single approach to determining relevant positions cannot be successfully applied to cohorts having different attributes. For example, software engineers in San Jose, Calif., significantly outnumber software engineers in Missoula, Mont. Accordingly, using the same approach to determine relevant positions for both cohorts will result in too many results for the densely populated area (San Jose) and too few results in the less densely populated area (Missoula).

Applying a comprehensive algorithm to determine relevant positions is too computationally intense, and keeping up with hundreds of millions of members and millions of jobs is prohibitive. In another example, a less comprehensive approach may be taken; however, such an approach does not provide the member with a usable list of available positions for areas with limited positions or with unique cohorts with overall less positions.

In other examples, there is great variation in the usability of some queries. For example, some groups, such as “Cowboys” in San Francisco, are relatively few as one skilled in the art may appreciate. Therefore, searching for positions for Cowboys in San Francisco may inherently not yield many results. Therefore, for this group, a less restrictive query would provide more results (e.g., cowboys in the Bay Area, or cowboys in central California).

In another example, “software engineer in India” will return many results. Therefore, a more restrictive query (e.g., including experience level, age, education, etc.) is more likely to return a reasonable number of positions (e.g., a number of positions that a person could view in a reasonable amount of time, such as an hour) without user intervention.

In another example embodiment, a search system ranks results according to member profile attributes (e.g., experience level, current position title, location, etc.), member activity features (e.g., interactions with the online social networking system, articles posted, comments, messages, web site visitations, etc.), and connections (e.g., network connection at the online social networking systems with those who may have posted the employment position).

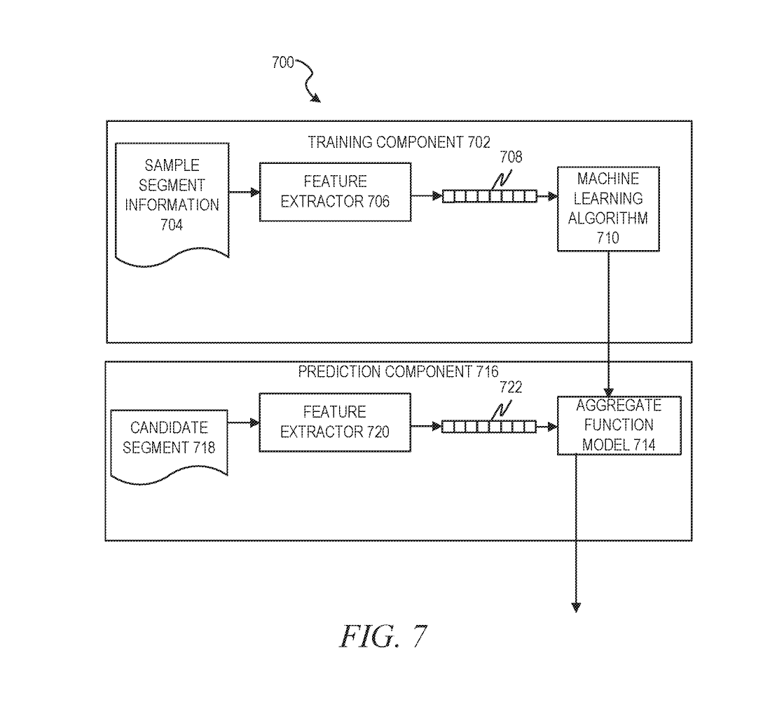

In another example embodiment, members are mapped to cohorts according to particular combinations of member attributes. One example of a system that performs this kind of mapping is depicted in FIG. 7.

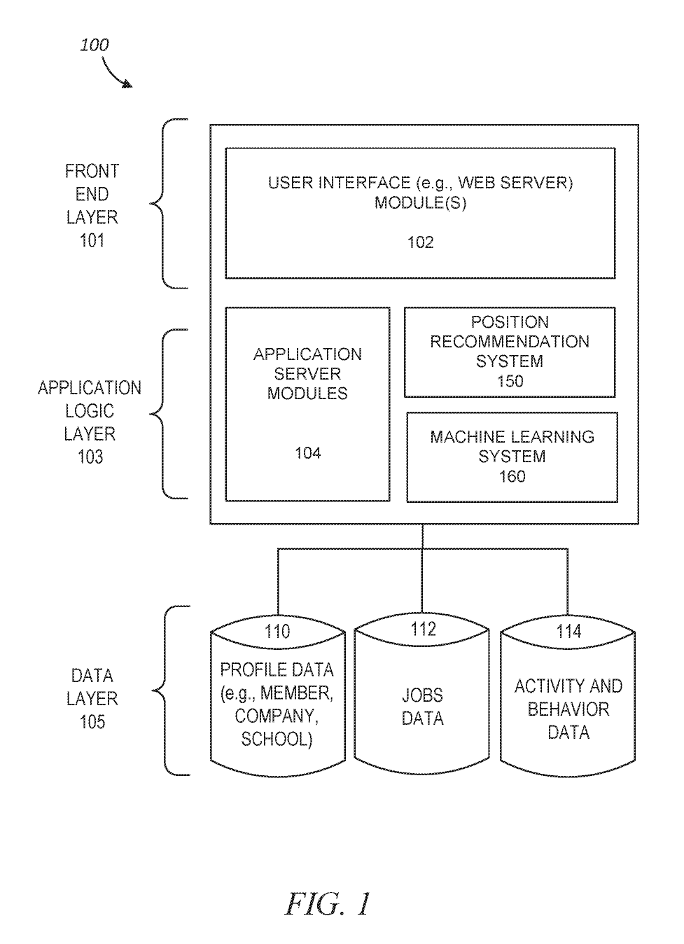

FIG. 1 is a block diagram illustrating various components or functional modules of a social networking service 100, in an example embodiment. In one example, the social networking service 100 includes a position recommendation system 150 that performs many of the operations described herein, and a machine learning system 160.

A front end layer 101 consists of one or more user interface modules (e.g., a web server) 102, which receive requests from various client computing devices and communicate appropriate responses to the requesting client devices. For example, the user interface module(s) 102 may receive requests in the form of Hypertext Transfer Protocol (HTTP) requests, or other web-based application programming interface (API) requests. In another example, the front end layer 101 receives requests from an application executing via a member's mobile computing device. In one example embodiment, the member requests a list of available employment positions using the application, and the application transmits an indicator, indicating the member's desire to view alternative positions, to the position recommendation system 150. As described herein, the position recommendation system 150 identifies a set of employment positions that are relevant to the member as described herein and transmits them to the member's mobile computing device or other device being used by the member.

An application logic layer 103 includes various application server modules 104, which, in conjunction with the user interface module(s) 102, may generate various user interfaces (e.g., web pages, applications, etc.) with data retrieved from various data sources in a data layer 105. In one example embodiment, the application logic layer 103 includes the position recommendation system 150 and the machine learning system 160.

In some examples, individual application server modules 104 may be used to implement the functionality associated with various services and features of the social networking service 100. For instance, the ability of an organization to establish a presence in the social graph of the social networking service 100, including the ability to establish a customized web page on behalf of an organization, post available employment positions, and to publish messages or status updates on behalf of an organization, may be a service implemented in independent application server modules 104. Similarly, a variety of other applications or services that are made available to members of the social networking service 100 may be embodied in their own application server modules 104. Alternatively, various applications may be embodied in a single application server module 104.

As illustrated, the data layer 105 includes, but is not necessarily limited to, several databases 110, 112, 114, such as a database 110 for storing profile data, including both member profile data and profile data for various organizations, name cluster data, member interactions, member queries, or the like. Database 112 is configured to store employment position postings, posting indices, or the like. In another example embodiment, the database 114 stores member activity and behavior data used to determine a member's inclination metric as described herein. In certain examples, the position recommendation system 150 retrieves available employment positions that are relevant to certain members by selecting records stored in the database 112.

Consistent with some examples, when a person initially registers to become a member of the social networking service 100, the person may be prompted to provide some personal information, such as his or her name, age (e.g., birthdate), gender, sexual orientation, interests, hobbies, contact information, home town, address, spouse's and/or family members' names, educational background (e.g., schools, majors, matriculation and/or graduation dates, etc.), occupation, employment history, employment preferences (e.g., location, company size, employer industry, etc.) skills, religion, professional organizations, and other properties and/or characteristics of the member. In one example embodiment, the social networking service 100 asks whether the member desires to participate in a program that implements the position recommendation system 150. This information is stored, for example, in the database 110. Similarly, when a representative of an organization initially registers the organization with the social networking service 100, the representative may be prompted to provide certain information about the organization. This information may be stored, for example, in the database 110, or another database (not shown).

The social networking service 100 may provide a broad range of other applications and services that allow members the opportunity to share and receive information, which is often customized to the interests of the member. For example, in some examples, the social networking service 100 may include a message sharing application that allows members to upload and share messages with other members. In some examples, members may be able to self-organize into groups, or interest groups, organized around a subject matter or topic of interest. In some examples, the social networking service 100 may host various job listings providing details of job openings within various organizations.

As members interact with the various applications, services, and content made available via the social networking service 100, information concerning content items interacted with, such as by viewing, playing, and the like, may be monitored, and information concerning the interactions may be stored, for example, as indicated in FIG. 1 by the database 114. In certain example embodiments, the database 114 stores member interactions such as, but not limited to, viewing received messages, clicking a link in a received message, updating a member profile, updating a specific parameter of a member profile, setting a profile indicator, using a specific term in the member profile, searching for alternative roles, reviewing job postings (e.g., available employment positions), requesting to receive notification of alternative roles, or other actions or interactions with the social networking service 100 that indicate an inclination to modify a current role for the member.

Although not shown, in some examples, the social networking service 100 provides an API module via which third-party applications can access various services and data provided by the social networking service 100. For example, using an API, a third-party application may provide a user interface and logic that enables the member to submit and/or configure a set of rules used by the position recommendation system 150. Such third-party applications may be browser-based applications or may be operating system specific. In particular, some third-party applications may reside and execute on one or more mobile devices (e.g., phones or tablet computing devices) having a mobile operating system.

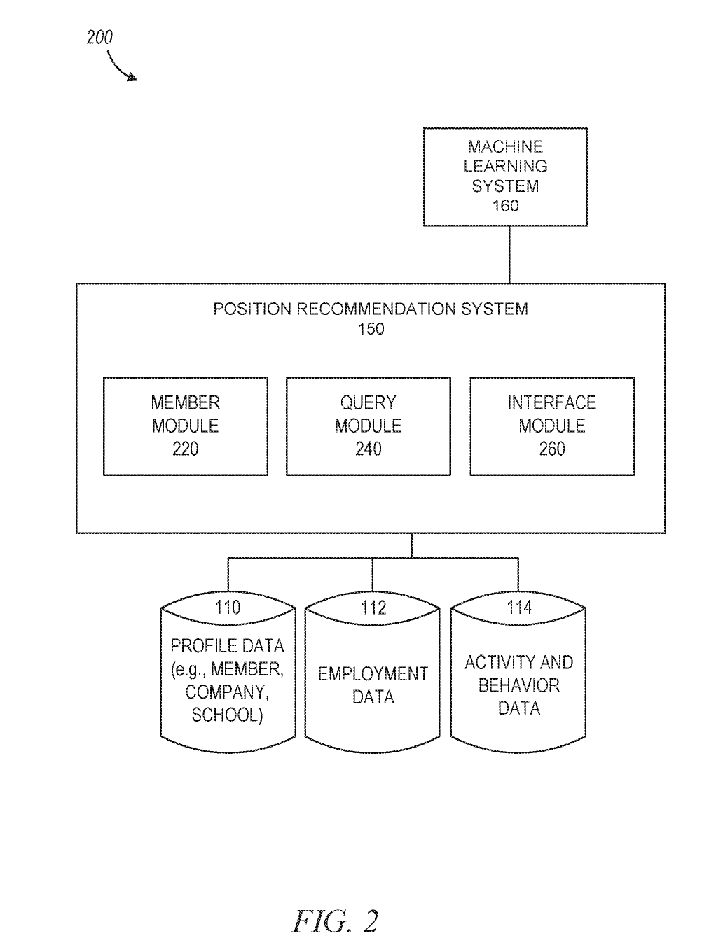

FIG. 2 is a block diagram illustrating a system 200 for recommending relevant positions, according to one example embodiment. In this example embodiment, the system 200 includes the machine learning system 160, the position recommendation system 150, and the databases 110, 112, and 114. The position recommendation system 150 includes a member module 220, a query module 240, and an interface module 260.

In one example embodiment, the member module 220 is configured to receive an indicator from a member of an social networking service, wherein the indicator indicates the member's desire to view available employment positions. As one skilled in the art may appreciate, the member module 220 may receive the indicator in many different ways. In certain examples, the member module 220 provides a user interface using a user interface module 102. For example, the member module 220 may generate a web page for accepting the indicator and transmit the web page to a computing device being used by the member. In another example, the member module 220 instructs an application executing at the computing device for the member to display a user interface to the member. In one example, the user interface includes a button that, when pressed, causes the indicator to be transmitted to the member module 220.

In response to a posting for an employment position being posted to the social networking service 100, in one example embodiment, the member module 220 parses the posting to identify specific fields (e.g., specific terms, inferred fields, etc.) that are included in the posting. The member module 220 may then apply tags to the posting. In this way, the position recommendation system 150 may more quickly identify positions that match query parameters because the member module 220 identifies fields stored in a key/value pair instead of searching the posting for relevant fields. Of course, as one skilled in the art may appreciate, the member module 220 parses the posting according to a language of the posting.

In one example embodiment, the member module 220 configures a batch system to map members to a cohort according to their profile parameters. The batch system may operate without user intervention, analyzing members one at a time and mapping them to a cohort. Thus, the member module 220 may include parameters for the cohort instead of individual parameters for each member. In this way, instead of optimizing a query for millions of members, the position recommendation system optimizes queries 100,000 cohorts, or less.

Another parameter that may be included in a query is the member's interactions and/or activity level (e.g., a number of interactions with the social networking service 100 per unit time, including comments, posts, likes, requests, web page loads, selections, or the like). In this example, the member module 220 retrieves a pre-computed query for a cohort and adds the member's interactions with the social networking service as an additional condition.

As will be later described, the member module 220 receives an indication that a member desires to view alternative employment positions and, in response, retrieves a query that is associated with the cohort mapped to the member.

As described herein, a cohort represents a grouping of members pertaining to a particular combination of user attributes for members of the social networking service 100. Thus, for example, a cohort may be for a particular title and region combination, such as “Computer Programmer” and “San Francisco Bay Area,” or a particular title, company, and region combination, such as “Computer Programmer,” “XYZ Corp.” and “San Francisco Bay Area.”

These cohorts are various combinations of the one or more attributes for which there exist submitted member data values in a database, such as in the database 110. Specifically, it shall be interpreted as meaning that the cohort is relevant to the one or more attributes of the member. This may mean that the cohort is grouped based on one of the attributes itself, or based on a sub-attribute of the attribute. For example, the first user may have a job title of “Computer Programmer” and a location of “San Francisco Bay Area,” and thus cohorts including “Software Product Manager”/“San Jose” and “Software Product Manager”/“Santa Clara” may bath be considered matches (assuming “Software Product Manager” is a sub-attribute of “Computer Programmer” in the title taxonomy), but cohorts including “Software Product Manager”/“Los Angeles” and even “Computer Programmer”/“New York” may not be considered matches. Additionally, cohorts segregated at a higher attribute level in the taxonomy may also be considered a match, such as a cohort including “Software Product Manager”/“California,” since California contains the San Francisco Bay Area and is therefore a super-attribute in the taxonomy.

Furthermore, cohorts that have not been segregated at all along the taxonomy of one of the attributes may also be considered matches. For example, if the cohort is for “Software Product Manager” but no location is specified, the cohort may still be considered a match.

Members are grouped into cohorts at a generalized level to determine an empirical probability distribution. This may involve removing one of the attributes of the initial cohort or moving one or more attributes of the initial cohort up one level in a hierarchy. For example, if an initial cohort includes a tuple including title, company, and region as attributes, then this cohort may be generalized to title and region. If the initial cohort includes a tuple including title and city, then this cohort may be generalized to title and region, or title and state, or title and country. If the initial cohort includes a tuple including title and region, then this cohort may be generalized to function and region.

It should be noted that this generalization may be based on the number of members in the cohort and involves an attempt to increase the number of members in the cohort beyond a predetermined threshold. As such, it is possible that the initial cohort already has more members than the predetermined threshold and thus no generalization is necessary. If that is not the case, however, then a systematic algorithm for finding a generalized version of the cohort that does have more members than the predetermined threshold may be followed. This algorithm may involve attempting to remove each attribute of the initial cohort to form intermediate cohorts and measuring the number of members in each intermediate cohort. Likewise, each attribute of the initial cohort is generalized up one level in a hierarchy to form additional intermediate cohorts, and the number of members in each of these intermediate cohorts is also measured. The intermediate cohort with the greatest number of members is then selected, and the number of members in the selected intermediate cohort is compared with the predetermined threshold. If the number of members in the selected intermediate cohort exceeds the predetermined threshold, then the selected intermediate cohort is selected as the final cohort. If not, however, the algorithm repeats for the selected intermediate cohort, generalizing its attributes by removing each, moving each up one level to form another set of intermediate cohorts, and then comparing the number of members in this other set of intermediate cohorts to the predetermined threshold. The process repeats until an intermediate cohort is found with more members than the predetermined threshold, and such an intermediate cohort is selected as the final cohort for the member.

In other example embodiments, the query module 240 applies a machine learning system 160 to learn queries for each cohort. In one example, the machine learning system 160 applies a complex rule (e.g., a rule that includes all member attributes defined in the cohort). The machine learning system 160 then repeatedly removes attributes until at least a threshold number of results are returned from the query.

In one example, the threshold number of results is 100. In response to a first set of results being 20, the machine learning system 160 removes a condition from the query, and re-executes the query at the database 112. The machine learning system 160 repeats these steps until the number of results that are returned exceeds the threshold value. Of course, other threshold values may be used and this disclosure is not limited in this regard.

In another example embodiment, the machine learning system 160 applies a simple rule (e.g., employment title and location). In response to the number of results exceeding the threshold value, the machine learning system 160 successively adds conditions to the query until the number of results returned is less than the threshold value. In one example, a first set of results is 1000, and the machine learning system 160 iteratively adds conditions to the query until the number of results is less than the threshold value (e.g., 100, or another value).

In another example embodiment, the member module 220 adds conditions to the query for the cohort according to the member's interactions and/or activities at the social networking service 100. In one example, the member module 220 adds the member's activity level (e.g., a specific number of interactions per unit time) as a condition to the query.

In one example embodiment, the interface module 260 is configured to cause the results of the query to be displayed to the member using an electronic user interface. In certain examples, the interface module 260 generates code for a web page that displays the results and transmits the code to a computing device being used by the member.

In another example embodiment, the interface module 260 transmits data to the computing device being used by the member where the data comprises sufficient information to direct generation of a display at the computing device. In one example, the sufficient information includes one or more buttons with their associated locations and/or functionality.

In one example embodiment, the interface module 260 ranks results according to attributes of the member that are not represented by the cohort. In one example, the cohort includes location, title, industry, experience level, but does not include an employer size (e.g., a number of employees). In this example, the interface module 260 ranks results according to a size of the employer. Thus, results that match the cohort are arranged to more closely match the member.

In one example embodiment, the position recommendation system 150 learns that a more restrictive query should be used for a larger city, and a less restrictive query should be used for a more rural area. For example, a query of “school teacher in Chicago” (a city having a population of almost 3 million) would likely yield many positions and would have to be further restricted to allow a member to practically view the results.

Similarly, “school teacher in Deer Lodge, Montana” (an area having a population of less than 3,000 people) would likely result in few results, and the query would not have to be restricted, or may have to be broadened (e.g., to view school teachers in Powell County, or the state of Montana) before a sufficient number of results would be returned. In another situation, a unique employment position, such as a Veterinary Acupuncturist, may yield few results regardless of location. In this example, a nationwide search for positions may be more relevant.

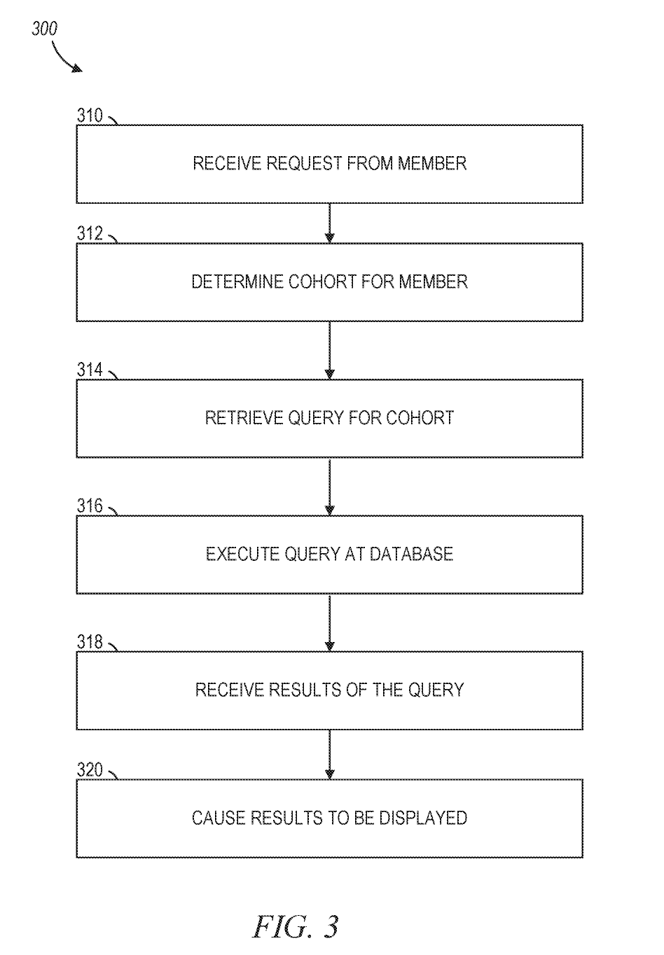

FIG. 3 is a flow chart diagram illustrating a method 300 for recommending relevant positions, according to one example embodiment. Operations in the method 300 are performed by one or more modules described in FIG. 2 and are indicated by reference thereto.

In one example embodiment, the method 300 begins at operation 310 and the member module 220 receives, from a member of the social networking service 100, a request to view available positions. For example, the member might manipulate a graphical user interface to initiate the request, and the member module 220 receives the request.

The method 300 continues at operation 312 and the member module 220 determines a cohort for the member as previously described. The method 300 continues at operation 314 and the query module 240 retrieves a query for the cohort. In certain example embodiments, queries for each cohort are stored in a database (e.g., the database 110). For example, the queries for the respective cohorts may be stored in a relational database with the query comprising an SQL statement. In this example, the results include a table of positions that satisfy the conditions of the SQL query. Of course, one skilled in the art may recognize other ways to store queries and map them to cohorts, and this disclosure is not limited in this regard.

The method 300 continues at operation 316 and the query module 240 submits the query to a database of positions. In one example, the query module 240 transmits the query to an electronic interface configured to receive such queries.

The method 300 continues at operation 318 and the query module 240 receives the results of the query. For example, the query module 240 may electronically receive a table of results from the database.

The method 300 continues at operation 320 and the interface module 260 generates an electronic interface to display the results. In one example, the interface module 260 generates a web page that displays the remaining positions and transmits the web page to a computing device being used by the member. In another example embodiment, the interface module 260 transmits the results to an application executing on the computing device being used by the member.

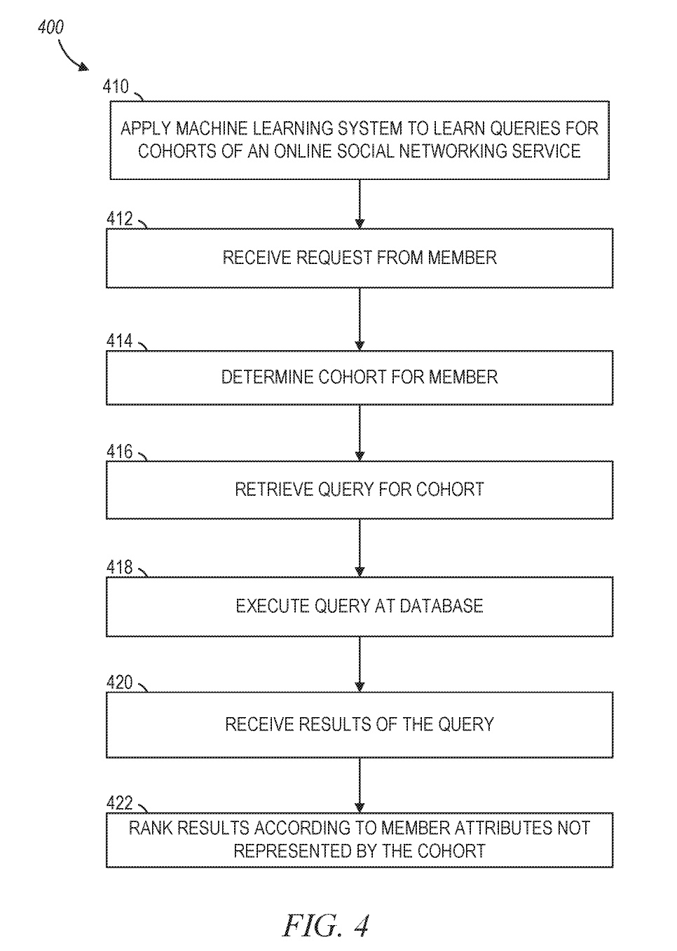

FIG. 4 is a flow chart diagram illustrating another method 400 of recommending relevant positions, according to one example embodiment. Operations in the method 400 are performed by one or more modules described in FIG. 2 and are indicated by reference thereto.

In one example embodiment, the method 400 begins and at operation 410, the query module 240 applies a machine learning system 160 to learn queries for each cohort. The method 400 continues at operation 412 and the member module 220 receives, from a member of the social networking service 100, a request to view available positions as previously described.

The method 400 continues at operation 414 and the member module 220 determines a cohort for the member as previously described. The method 400 continues at operation 416 and the query module 240 retrieves a query for the cohort by selecting the query that is mapped to the cohort in a database of queries.

The method 400 continues at operation 418 and the query module 240 submits the query to a database of positions. In one example, the query module 240 transmits the query to an electronic interface configured to receive such queries.

The method 400 continues at operation 420 and the query module 240 receives the results of the query. For example, the query module 240 may electronically receive a table of results from the database.

The method 400 continues at operation 422 and the interface module 260 ranks results according to member attributes that are not represented by the cohort as previously described.

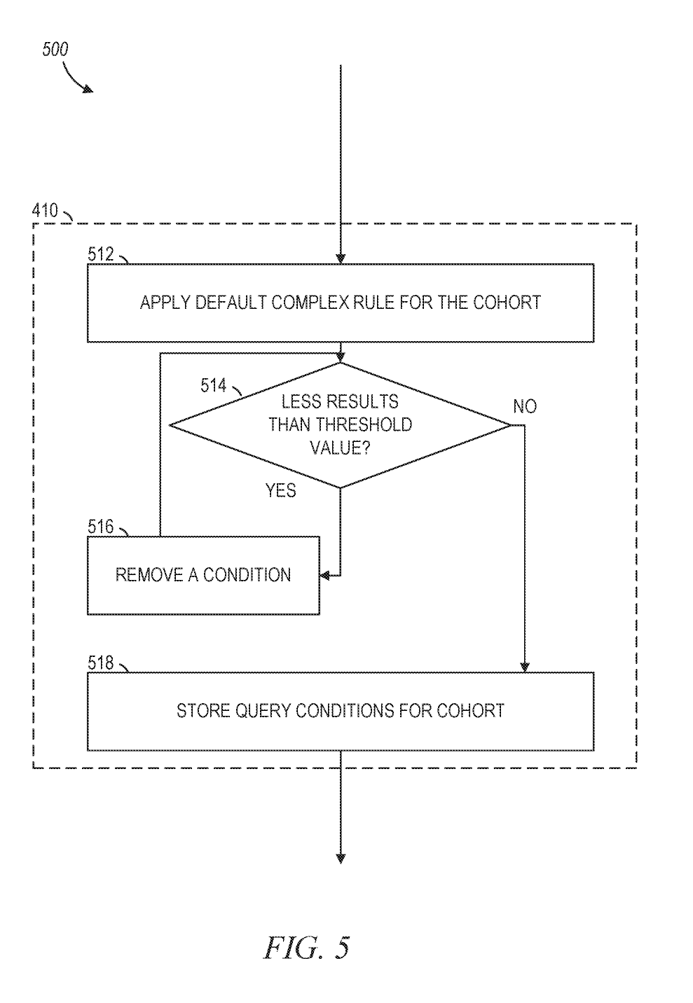

FIG. 5 is a flow chart diagram illustrating a method 500 of training a machine learning system, according to another example embodiment. Operations in the method 500 are performed by one or more modules described in FIG. 2 and are indicated by reference thereto.

In one example embodiment, the method 500 represents operation 410 of FIG. 4. At operation 512, the query module 240 applies a default complex rule for a cohort. For example, a default complex rule may include 10 or more conditions in a query for positions.

The method 500 continues at operation 514 and the query module 240 determines whether a number of results from the query is less than a threshold value. In response to the number of results being below the threshold value, the method 500 continues at operation 516 and the query module 240 removes a condition. For example, the query module 240 may remove one of the original 10 conditions applied in operation 512.

In response to the number of results from the query not being less than the threshold value, the method 500 continues at operation 518 and the query module 240 stores the query in a database of queries such that it is mapped to the cohort.

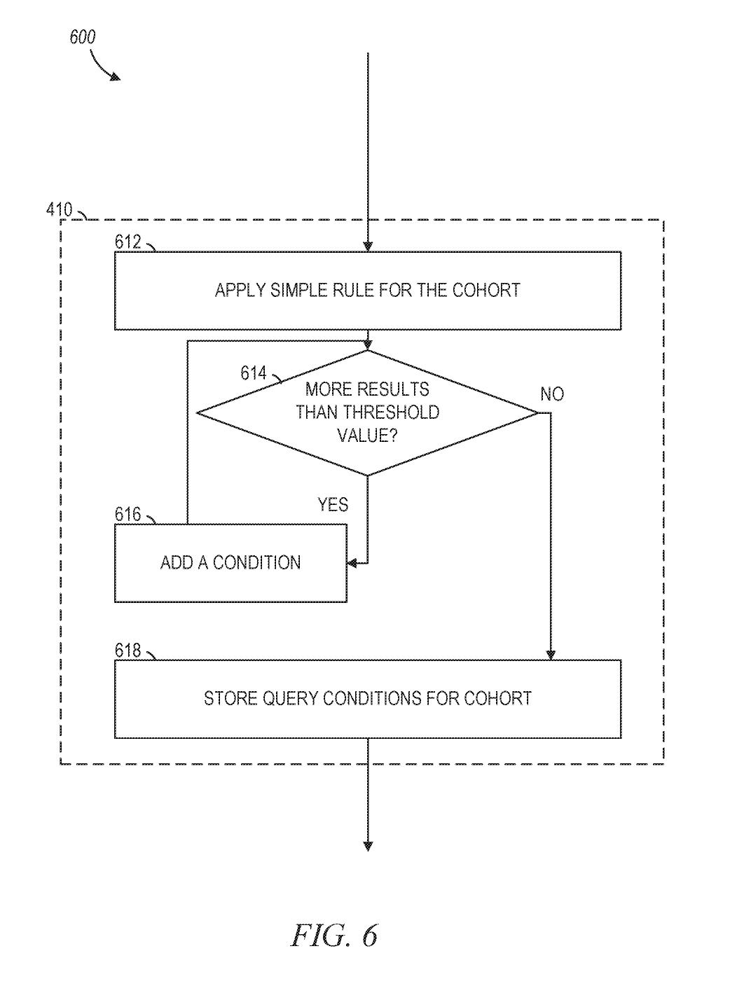

FIG. 6 is a flow chart diagram illustrating a method 600 of training a machine learning system, according to another example embodiment. Operations in the method 600 are performed by one or more modules described in FIG. 2 and are indicated by reference thereto.

In one example embodiment, the method 600 represents operation 410 of FIG. 4. At operation 612, the query module 240 applies a default simple rule for a cohort. For example, a default simple rule may include title and location, such as, but not limited to, title: “software engineer” and location: “San Francisco.”

The method 600 continues at operation 614 and the query module 240 determines whether a number of results from the query is more than a threshold value. In response to the number of results being above the threshold value, the method 600 continues at operation 616 and the query module 240 adds a condition. For example, the query module 240 may add an experience level (e.g., a number of years) as a condition of the query.

In response to the number of results from the query not being more than the threshold value, the method 600 continues at operation 618 and the query, module 240 stores the query in a database of queries such that it is mapped to the cohort.

FIG. 7 is a block diagram illustrating a system for determining a cohort for a member, according to one example embodiment. In a training component, sample segment (i.e., a collection of members belonging to a cohort) information 704 from sample segment data is fed to a feature extractor 706, which acts to extract curated features 708 from the sample segment information 704.

Thus, for example, the feature extractor 706 may extract features such as segment attributes (e.g., location, title, etc.) from the sample segment information 704. Extraction may be performed via a number of different extraction techniques. In a simple case, the attributes may be directly extracted from the sample segment information 704. In other example embodiments, more complex transformations and/or pre-processing may be performed, such as mapping of the segment attributes to social network attribute taxonomy categories.

The curated features 708 may be fed to a machine learning algorithm 710 along with known valid ranges for cohort data for each of the segments in the sample segment information 704. The machine learning algorithm 710 then trains an aggregate function model 714 based on the curated features 708 and known valid ranges for cohort values. The machine learning algorithm 710 may be selected from among many different potential supervised or unsupervised machine learning algorithms. Examples of supervised machine learning algorithms include artificial neural networks, Bayesian networks, instance-based learning, support vector machines, random forests, linear classifiers, quadratic classifiers, k-nearest neighbor, decision trees, and hidden Markov models. Examples of unsupervised machine learning algorithms include expectation-maximization algorithms, vector quantization, and information bottleneck method. In an example embodiment, a binary logistic regression model is used. Binary logistic regression deals with situations in which the observed outcome for a dependent variable can have only two possible types. Logistic regression is used to predict the odds of one case or the other being true based on values of independent variables (predictors).

Specifically, the aggregate function model 714 may be trained to output a cohort as described above. Other parameters and weights for the aggregation functions may also be output by the aggregate function model 714.

In a prediction component 716, a candidate segment 718 is fed to a feature extractor 720, which acts to extract curated features 722 from the candidate segment 718. The curated features 722 are then used as input to the trained aggregate function model 714, which outputs a cohort.

It should be noted that while the feature extractor 706 and the feature extractor 720 are depicted as separate components, they may be the same component in some example embodiments. Additionally, a large number of different types of features could be extracted using the feature extractors 706 and 720. Furthermore, while in an example embodiment the features extracted by the feature extractor 706 are the same as the features extracted by the feature extractor 720, in other example embodiments there may be differences in the features.

A plurality of intermediate cohorts are derived by generalizing each of the one or more attributes of the cohort up one level. It is then determined if the number of members in (e.g., mapped to) at least one of these intermediate cohorts exceeds a predetermined threshold. If so, then least one of the intermediate cohorts whose number of members exceeds a predetermined threshold is selected. If not, then the method loops back for the intermediate cohort having the highest number of members.

In another example embodiment, the cohorts are limited to a specific organizational size. In one example, the cohorts are limited to corporations with fewer than 50 people, but of course, any value may be used and this disclosure is not limited in this regard. In other embodiments, the cohorts are for a specific industry and a specific size.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-7 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “Internet of Things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Software Architecture

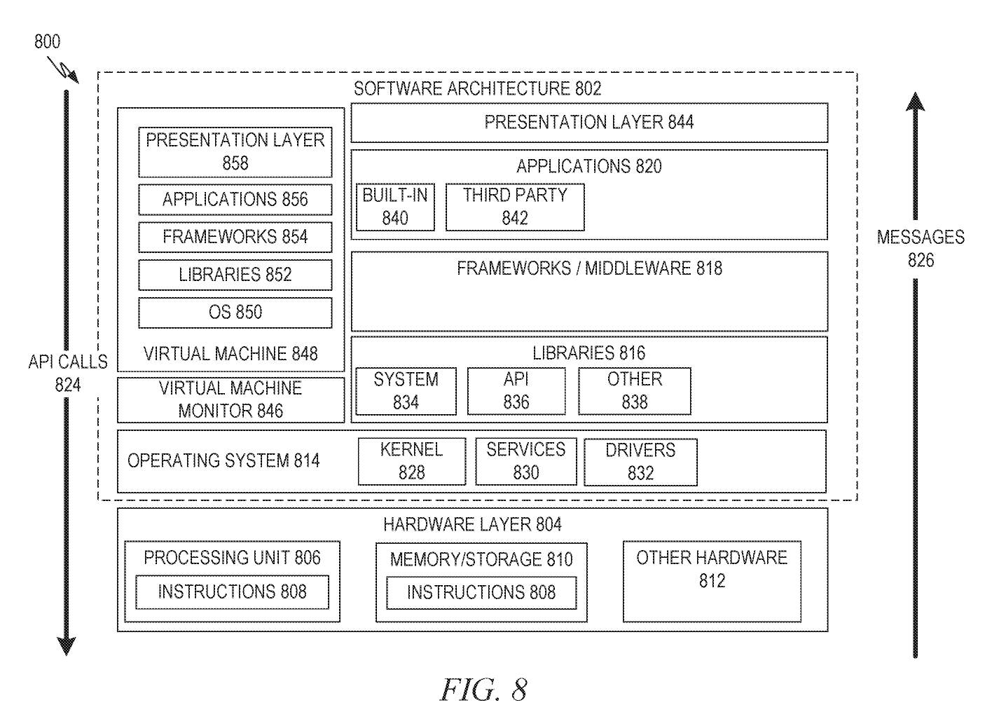

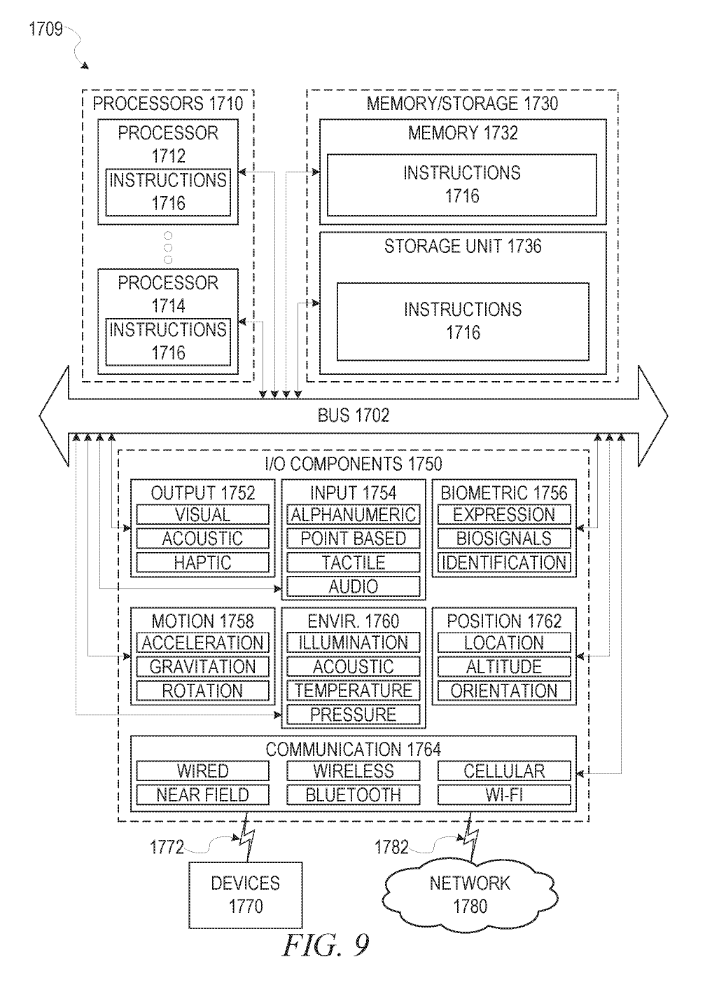

FIG. 8 is a block diagram 800 illustrating a representative software architecture 802, which may be used in conjunction with various hardware architectures herein described. FIG. 8 is merely a non-limiting example of a software architecture, and it will be appreciated that many other architectures may be implemented to facilitate the functionality described herein. The software architecture 802 may be executing on hardware such as a machine 1709 of FIG. 9 that includes, among other things, processors 1710, memory/storage 1730, and I/O components 1750. A representative hardware layer 804 is illustrated and can represent, for example, the machine 1709 of FIG. 9. The representative hardware layer 804 comprises one or more processing units 806 having associated executable instructions 808. The executable instructions 808 represent the executable instructions of the software architecture 802, including implementation of the methods, modules, and so forth of FIGS. 1-7. The hardware layer 804 also includes memory and/or storage modules 810, which also have the executable instructions 808. The hardware layer 804 may also comprise other hardware 812, which represents any other hardware of the hardware layer 804, such as the other hardware illustrated as part of the machine 1709.

In the example architecture of FIG. 8, the software architecture 802 may be conceptualized as a stack of layers where each layer provides particular functionality. For example, the software architecture 802 may include layers such as an operating system 814, libraries 816, frameworks/middleware 818, applications 820, and a presentation layer 844. Operationally, the applications 820 and/or other components within the layers may invoke API calls 824 through the software stack and receive responses, returned values, and so forth, illustrated as messages 826, in response to the API calls 824. The layers illustrated are representative in nature and not all software architectures have all layers. For example, some mobile or special-purpose operating systems may not provide a layer of frameworks/middleware 818, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers Universal Serial Bus (USB) drivers), Wi-Fi® drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than by interfacing directly with the underlying operating system 814 functionality (e.g., kernel 828, services 830, and/or drivers 832). The libraries 816 may include system libraries 834 (e.g., C standard library) that may provide functions such as memory allocation functions, string manipulation functions, mathematical functions, and the like. In addition, the libraries 816 may include API libraries 836 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be utilized by the applications 820 and/or other software components/modules. For example, the frameworks 818 may provide various graphic user interface (GUI) functions, high-level resource management, high-level location services, and so forth. The frameworks 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. The third-party applications 842 may include any of the built-in applications 840 as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™ Android™, Windows® Phone, or other mobile operating systems. In this example, the third-party application 842 may invoke the API calls 824 provided by the mobile operating system such as the operating system 814 to facilitate functionality described herein.

The applications 820 may utilize built-in operating system 814 functions kernel 828, services 830, and/or drivers 832), libraries 816 (e.g., system libraries 834, API libraries 836, and other libraries 838), and frameworks/middleware 818 to create user interfaces to interact with users of the system. Alternatively, or additionally, in some systems, interactions with a user may occur through a presentation layer, such as the presentation layer 844. In these systems, the application/module “logic” can be separated from the aspects of the application/module that interact with a user.

Some software architectures utilize virtual machines. In the example of FIG. 8, this is illustrated by a virtual machine 848. A virtual machine creates a software environment where applications/modules can execute as if they were executing on a hardware machine (such as the machine 1709 of FIG. 9, for example). A virtual machine is hosted by a host operating system (e.g., operating system 814 in FIG. 8) and typically, although not always, has a virtual machine monitor 846, which manages the operation of the virtual machine 848 as well as the interface with the host operating system (e.g., operating system 814). A software architecture executes within the virtual machine 848, such as an operating system 850, libraries 852, frameworks/middleware 854, applications 856, and/or a presentation layer 858. These layers of software architecture executing within the virtual machine 848 can be the same as corresponding layers previously described or may be different.

### Example Machine Architecture and Machine-Readable Medium

FIG. 9 is a block diagram illustrating components of a machine 1709, according to some example embodiments, able to read instructions from a machine-readable medium (e.g., a machine-readable storage medium) and perform any one or more of the methodologies discussed herein. Specifically, FIG. 9 shows a diagrammatic representation of the machine 1709 in the example form of a computer system, within which instructions 1716 (e.g., software, a program, an application, an applet, an app, or other executable code) for causing the machine 1709 to perform any one or more of the methodologies discussed herein may be executed. The instructions 1716 transform the general, non-programmed machine into a particular machine programmed to carry out the described and illustrated functions in the manner described. In alternative embodiments, the machine 1709 operates as a standalone device or may be coupled (e.g., networked) to other machines. In a networked deployment, the machine 1709 may operate in the capacity of a server machine or a client machine in a server-client network environment, or as a peer machine in a peer-to-peer (or distributed) network environment. The machine 1709 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1716, sequentially or otherwise, that specify actions to be taken by the machine 1709. Further, while only a single machine 1709 is illustrated, the term “machine” shall also be taken to include a collection of machines 1700 that individually or jointly execute the instructions 1716 to perform any one or more of the methodologies discussed herein.

The machine 1709 may include processors 1710, memory/storage 1730, and I/O components 1750, which may be configured to communicate with each other such as via a bus 1702. In an example embodiment, the processors 1710 (e.g., a Central Processing Unit (CPU), a Reduced Instruction Set Computing (RISC) processor, a Complex instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1712 and a processor 1714 that may execute the instructions 1716. The term “processor” is intended to include multi-core processors that may comprise two or more independent processors (sometimes referred to as “cores”) that may execute the instructions 1716 contemporaneously. Although FIG. 9 shows multiple processors 1710, the machine 1709 may include a single processor with a single core, a single processor with multiple cores (e.g., a multi-core processor), multiple processors with a single core, multiple processors with multiples cores, or any combination thereof.

The memory/storage 1730 may include a memory 1732, such as a main memory, or other memory storage, and a storage unit 1736, both accessible to the processors 1710 such as via the bus 1702. The storage unit 1736 and memory 1732 store the instructions 1716 embodying any one or more of the methodologies or functions described herein. The instructions 1716 may also reside, completely or partially, within the memory 1732, within the storage unit 1736, within at least one of the processors 1710 (e.g., within the processor's cache memory), or any suitable combination thereof, during execution thereof by the machine 1709. Accordingly, the memory 1732, the storage unit 1736, and the memory of the processors 1710 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1716. The term “machine-readable medium” shall also be taken to include any medium, or combination of multiple media, that is capable of storing instructions (e.g., instructions 1716) for execution by a machine (e.g., machine 1709), such that the instructions, when executed by one or more processors of the machine (e.g., processors 1710), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1750 may include a wide variety of components to receive input, provide output, produce output, transmit information, exchange information, capture measurements, and so on. The specific I/O components 1750 that are included in a particular machine will depend on the type of machine. For example, portable machines such as mobile phones will likely include a touch input device or other such input mechanisms, while a headless server machine will likely not include such a touch input device. It will be appreciated that the I/O components 1750 may include many other components that are not shown in FIG. 9. The I/O components 1750 are grouped according to functionality merely for simplifying the following discussion and the grouping is in no way limiting. In various example embodiments, the I/O components 1750 may include output components 1752 and input components 1754. The output components 1752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1750 may include biometric components 1756, motion components 1758, environmental components 1760, or position components 1762, among a wide array of other components. For example, the biometric components 1756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1758 may include acceleration sensor components (e.g., accelerometer), gravitation sensor components, rotation sensor components (e.g., gyroscope), and so forth. The environmental components 1760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1750 may include communication components 1764 operable to couple the machine 1709 to a network 1780 or devices 1770 via a coupling 1782 and a coupling 1772, respectively. For example, the communication components 1764 may include a network interface component or other suitable device to interface with the network 1780. In further examples, the communication components 1764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1770 may be another machine or any of a wide variety of peripheral devices (e.g., a peripheral device coupled via a USB).

Moreover, the communication components 1764 may detect identifiers or include components operable to detect identifiers. For example, the communication components 1764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1764, such as location via Internet Protocol (IP) geolocation, location via Wi-Fi® signal triangulation, location via detecting an NEC beacon signal that may indicate a particular location, and so forth.

### Transmission Medium

In various example embodiments, one or more portions of the network 1780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1780 or a portion of the network 1780 may include a wireless or cellular network and the coupling 1782 may be a Code Division Multiple Access (CDMA) connection, a Global System for Mobile communications (GSM) connection, or another type of cellular or wireless coupling. In this example, the coupling 1782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1716 may be transmitted or received over the network 1780 using a transmission medium via a network interface device (e.g., a network interface component included in the communication components 1764) and utilizing any one of a number of well-known transfer protocols (e.g., Hypertext Transfer Protocol (HTTP)). Similarly, the instructions 1716 may be transmitted or received using a transmission medium via the coupling 1772 (e.g., a peer-to-peer coupling) to the devices 1770. The term “transmission medium” shall be taken to include any intangible medium that is capable of storing, encoding, or carrying the instructions 1716 for execution by the machine 1709, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a machine-readable memory having instructions stored thereon, which, when executed by a processor, cause the processor to perform operations comprising:
receiving a request from a member for available employment positions posted at a social networking service;
determining a cohort for the member, the cohort comprising a grouping of members pertaining to a particular combination of user attributes;
retrieving a query that is associated with the cohort for the member;
transmitting the query to a database of employment positions;
receiving results of the query; and
causing the results of the query to be displayed to the member using an electronic user interface.

2. The system of claim 1, wherein the operations further comprise training a machine learning system to learn a query for the cohort by applying a complex query and decreasing the complexity of the query until at least a threshold number of results are received.

3. The system of claim 1, wherein the operations further comprise training a machine learning system to learn a query for the cohort by applying a simple query and increasing the complexity of the query until less than a threshold number of results are received.

4. The system of claim 1, wherein a machine learning system is configured to learn queries for a plurality of cohorts in an offline processing batch.

5. The system of claim 1, wherein the query additionally includes the member's interactions and activities at the social networking service.

6. The system of claim 1, wherein the cohort is determined using at least the title of a current employment position for the member and a current employment location for the member.

7. The system of claim 1, further comprising ranking the results according to attributes of the member that are not represented by the cohort.

8. A method comprising:
receiving a request from a member for available employment positions posted at a social networking service;
determining a cohort for the member, the cohort comprising a grouping of members pertaining to a particular combination of user attributes;
retrieving a query that is associated with the cohort for the member;
executing the query at a database of employment positions;
receiving results of the query, and
causing the results of the query to be displayed to the member using an electronic user interface.

9. The method of claim 8, further comprising training a machine learning system to learn a query for the cohort by applying a complex query and decreasing the complexity of the query until at least a threshold number of results are received.

10. The method of claim 8, further comprising training a machine learning system to learn a query for the cohort by applying a simple query and increasing the complexity of the query until less than a threshold number of results are received.

11. The method of claim 8, further comprising training a machine learning system to learn queries for a plurality of cohorts in an offline processing batch.

12. The method of claim 8, further comprising updating the query associated with the cohort according to the member's interactions and activities at the social networking service.

13. The method of claim 8, wherein the cohort is determined using at least the title of a current employment position for the member and a current employment location for the member.

14. The method of claim 8, further comprising ranking the results according to attributes of the member that are not represented by the cohort.

15. A machine-readable hardware medium having instructions stored thereon, which, when executed by a processor, cause the processor to perform:
receiving a request from a member for available employment positions posted at a social networking service;
determining a cohort for the member, the cohort comprising a grouping of members pertaining to a particular combination of user attributes;
retrieving a query that is associated with the cohort for the member;
transmitting the query to a database of employment positions;
receiving results of the query; and
causing the results of the query to be displayed to the member using an electronic user interface.

16. The machine-readable hardware medium of claim 15, wherein the instructions further cause the processor to perform:
training a machine learning system to learn a query for the cohort by applying a complex query and decreasing the complexity of the query until at least a threshold number of results are received.

17. The machine-readable hardware medium of claim 15, wherein the instructions further cause the processor to train a machine learning system to learn a query for the cohort by applying a simple query and increasing the complexity of the query until less than a threshold number of results are received.

18. The machine-readable hardware medium of claim 15, wherein the instructions further cause the processor to train a machine learning system to learn queries for a plurality of cohorts in one or more offline processing batches.

19. The machine-readable hardware medium of claim 15, wherein the query, additionally includes the member's interactions and activities at the social networking service.

20. The machine-readable hardware medium of claim 15, wherein the cohort is determined using at least the title of a current employment position for the member and a current employment location for the member.
